(19) United States
(12) Patent Application Publication
(10) Pub. No.: US 2006/0054433 A1
(43) Pub. Date: Mar. 16, 2006

(54) Cryogenic fluid mass damper using charged particulates for stiction-free damping

(76) Inventors: Steve L. Hadden, Peoria, AZ (US); Thomas R. Kreider, Mesa, AZ (US); Mason A. Peck, Ithaca, NY (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/942,289

(22) Filed: Sep. 15, 2004

(51) Int. Cl. F16F 9/06

(52) U.S. Cl. 188/269

(57) ABSTRACT

A mass damper is provided for damping a mass. The mass damper includes a housing configured to couple to the mass and a plurality of electrostatically charged particles disposed within the housing, where the particles do not clump to one another or stick to the housing.

### FIELD OF THE INVENTION

The present invention generally relates to vibration damping and isolation, and more particularly relates to an apparatus that uses charged particulates, without liquid media, to dampen vibration.

### BACKGROUND OF THE INVENTION

A precision pointing system carrying a sensor, such as a telescope as its payload, may be susceptible to disturbances that produce structural vibrations and, consequently, pointing errors. Such vibrations may be attributed to mechanical components or assemblies, such as reaction wheel assemblies that are used as actuators in the precision pointing system. For the most part, because these systems tend not to have significant, inherent damping, these structural vibrations may degrade system performance and even cause structural fatigue over time. Therefore, an efficient means of damping the system may be needed.

Typically, to minimize performance degradation caused by vibrations, a passive-mass damping and isolation system is used for damping the structure and isolating the payload carried by a precision isolation system. One type of passive mass damping and isolation system is a fluid damper. Fluid dampers operate by displacing a viscous fluid from one fluid reservoir to another fluid reservoir through a restrictive passage. Shearing of the viscous fluid as it flows through the restrictive passage provides a force that is proportional to velocity, i.e. a damping force.

In these types of dampers, the viscous fluid is typically water, oil, or any one of numerous other fluid substances that are not in the gas, plasma, or solid phase. Although these fluids may be used in damping mechanisms that operate in environments where the range of temperature and pressure correspond to the fluid's liquid phase, they are inappropriate for environments outside this range. For instance, in the aerospace context where damping mechanisms may be exposed to temperatures that approach absolute zero, most of the fluids used in fluid dampers have low viscosity and/or may be a solid rather than a fluid.

In other types of dampers, such as pneumatic fluid mass dampers, gases are used. Pneumatic fluid mass dampers operate by varying pressure, temperature, and gas viscosity. However, in extreme low temperatures, such as 0° Kelvin, gas-to-liquid phase changes may occur. Such changes are generally undesirable because when the gas changes into a liquid, the resulting volume of liquid and gas may not adequately absorb the system vibration and instead may begin to vibrate itself.

One approach to addressing the above-mentioned drawbacks was developed by some of the inventors of the present invention. The prior approach, disclosed in U.S. patent application Ser. No. 10/728,225 filed Dec. 3, 2003 entitled “Apparatus for Damping Vibration Using Macro Particulates,” and assigned to the assignee of the instant application, provides a mass damping system including a container within which a plurality of particulates is disposed. Although this prior approach addresses at least some of the above-noted drawbacks, it too presents certain drawbacks. In particular, although particulates may be insusceptible to phase change at extreme low temperatures, they may clump together into solids and vibrate with the mass instead of damping the mass.

Accordingly, there is a need for an improved vibration damping system whose constituents do not clump and that can be used in most temperature ranges, particularly in extreme cryogenic temperature environments or extreme heat environments. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A mass damper is provided for damping a mass. The mass damper includes an electrostatically charged housing configured to couple to the mass and a plurality of electrostatically charged particles disposed within the housing, each particle electrostatically charged with like polarity to that of the electrostatically charged housing.

Another embodiment of the mass damper includes a housing, a plurality of particles, and a power source. The housing is configured to couple to the mass. The plurality of particles is disposed within the housing. The power source is coupled to the housing and configured to supply an electric potential thereto and electrostatically charge the housing, whereby when one of the particles of the plurality of particles contacts the housing, the particle is electrostatically charged.

Yet another embodiment of the mass damper includes a housing, a plurality of particles, a conductive element and a power source. The housing is configured to couple to the mass. The plurality of particles is disposed within the housing. The conductive element is disposed within the plurality of particles. The power source is coupled to the housing and configured to supply an electric potential to the conductive element and electrostatically charge the conductive element, whereby the particle is electrostatically charged when one of the particles of the plurality of particles contacts the conductive element.

Still yet another embodiment of the invention includes a housing, a plurality of particles, and a high-energy light source. The housing comprises negatively charged non-conductive material and is configured to couple to the mass. The plurality of particles is disposed within the housing. The high-energy light source is aimed at the plurality of particles and configured to direct high-energy photons toward at least one particle of the plurality of particles to thereby charge the particle.

### BRIEF DESCRIPTION OF THE DRAWINGS

The present invention will hereinafter be described in conjunction with the following drawing figures, wherein like numerals denote like elements, and

FIG. 1 is a schematic, cross sectional view of an exemplary mass damper;

FIG. 2 is a schematic, cross sectional view of another exemplary mass damper;

FIG. 3 is a schematic, cross sectional view of another exemplary mass damper;

FIG. 4 is a schematic, cross sectional view of yet another exemplary mass damper; and

FIG. 5 is a schematic, cross sectional view of still yet another exemplary mass damper.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

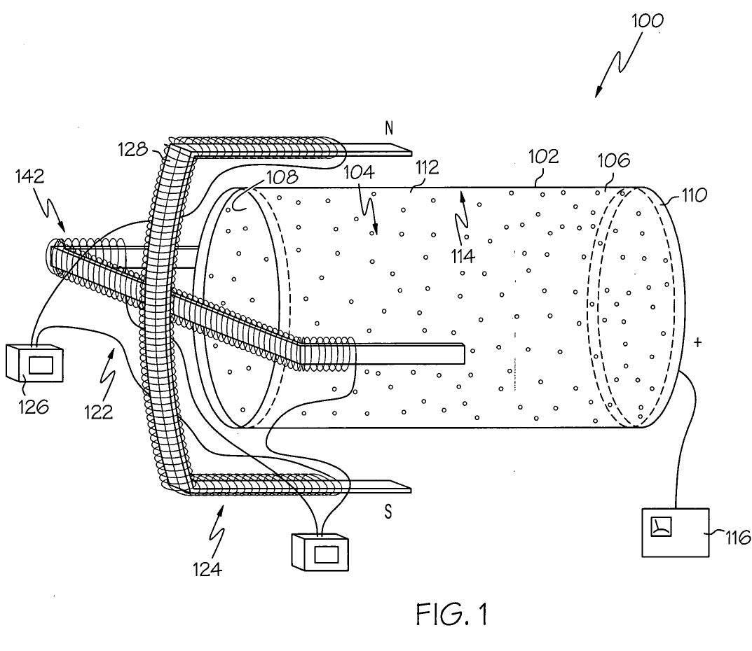

FIG. 1 illustrates a mass damping system 100 according to an exemplary embodiment of the invention. The system 100 includes a housing 102, a plurality of particles 104, and an electrostatic charge supply 116. The housing 102 has a cylindrical sidewall 106 and two end walls 108, 110 coupled to each of the ends of the cylindrical sidewall 106. The walls 106, 108, 110 include an interior surface 114 that defines a chamber 112 within the housing 102. Although the housing 102 is described herein as being cylindrical, it will be appreciated by those with skill that any one of a number of different shapes may be employed, such as for example, rectangular, prism-shaped, or square.

The housing 102 may be constructed of any one of numerous types of materials that are either conductive or non-conductive (insulating). Conductive materials include, but are not limited to metallic materials, such as copper, aluminum, iron, and steel, or graphite, and insulating materials include but are not limited to glass, rubber, and ceramic. In either case, as will be discussed in more detail further below, an electrostatic charge is maintained on the housing 102.

The plurality of particles 104 are disposed within the housing chamber 112 and are used to absorb vibration from a vibrating mass. Preferably, the plurality of particles 104 has properties that allow it to simulate a homogenous fluid with inherent shear. Similar to the housing 102, an electrostatic charge is also maintained on each of the plurality of particles 104. The electrostatic charge on the particles 104 is of the same polarity as that on the housing 102. The like electrostatic charge on the housing 102 and the particles 104 cause the housing 102 and particles 104 to repel one another, and the individual particles 104 to repel one another. As a result, particle clumping does not occur and the particles 104 simulate a fluid.

The electrostatic charges on the housing 102 and the particles 104 may be induced in any one of numerous manners. For example, electricity may be introduced into the system 100 to cause the system components to have like electrostatic charges. In other examples, light or nuclear energy may be introduced into the system 100. The method by which electrostatic charges are induced largely depends upon the materials from which the housing 102 and the plurality of particles comprise. Examples of various charging methods will now be described in detail below. It will be appreciated that system 100 components can have either a positive or negative charge, and although the components are described below and/or illustrated as having a positive charge, they may alternatively have a negative charge.

Returning to FIG. 1, in the exemplary embodiment depicted therein both the housing 102 and plurality of particles 104 are made of conductive material, and the electrostatic charge supply 116 is an electric power supply. The power supply 116 is coupled to the housing 102 and is configured to create a deficiency of electrons in the housing 102 so that it becomes positively charged. Preferably, the power supply 116 is configured to carry the electrons away from the system 100. Thus, when one of the particles 104 contacts the housing 102, it too becomes positively charged, as it loses an electron to the positively-charged housing 102. Once the particle 104 becomes positively charged, it repels the positively-charged housing 102. Over time, more and more of the particles 104 contact the housing 102 and become positively charged, until substantially all of the particles 104 have like electrostatic charges. As a result, the particles 104 repel one another and the individual particles 104 do not clump. Additionally, the particles 104 do not adhere to the housing 102.

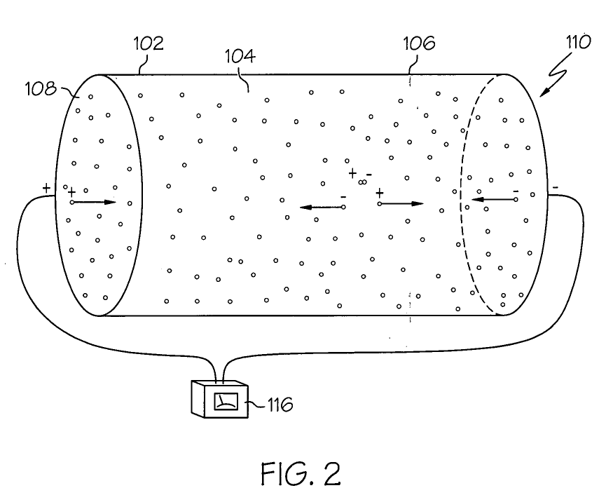

In another exemplary embodiment, such as depicted in FIG. 2, the housing cylindrical sidewall 106 is constructed of an insulating material, the end walls 108, 110 are made of a conducting material, and the power supply 116 is coupled to both end walls 108, 110. Those with skill in the art will appreciate that alternatively separate power supplies may be coupled to each of the end walls 108, 110. In one exemplary embodiment, the power supply 116 provides an electric potential across the end walls 108, 110 so that the electrons from one end wall 108 are pulled to the other end wall 110 to create an electron deficiency in one end wall 108 (positively-charged end wall 108) and an excess in the other end wall 110 (negatively-charged end wall).

As the particles 104 contact the positively-charged end wall 108, they lose an electron to become positively charged. Accordingly, the particles 104 repel the positively-charged end wall 108 and each other. At the other end of the housing 102, as particles contact the negatively-charged end wall 110, they gain an electron to become negatively charged. Thus, negatively-charged particles 104 repel the end wall 110 and one another. As the particles 104 are agitated and move toward the middle of the housing 102, the positively-charged particles come into contact with the negatively-charged particles. When two of such types of particles 104 contact one another, the negatively-charged particle donates its excess electron to the positively-charged particle thereby neutralizing both particles. Consequently, both particles become like-charged and repel one another.

Because numerous particles are included in the plurality of particles 104, the particles behave like cold, dense plasma when interacting with one another. As the particles 104 repel each other and either end wall 108, 110, kinematic motion of the particles 104 results. Thus, the particles 104 “self-mix” to further reduce clumping.

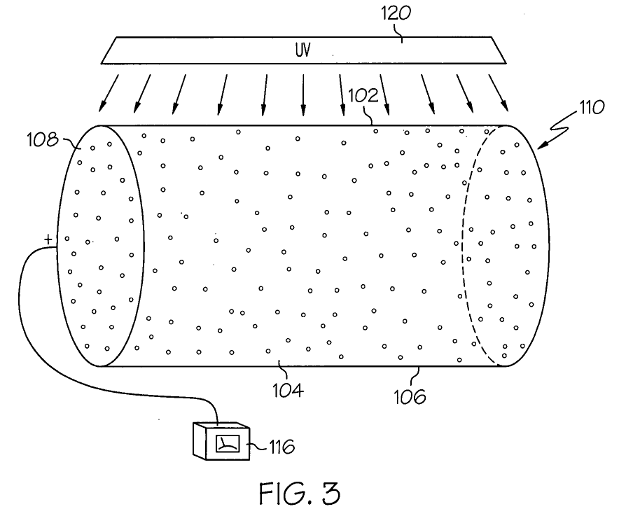

FIG. 3 illustrates still yet another embodiment. In this exemplary embodiment, the housing 102 is constructed of a conductive material and the particles 104 are made of an insulating material, such as plastic. The power supply 116 is coupled to the housing 102 and configured to positively charge the housing walls 106, 108, 110. An ultraviolet light source 120 is positioned proximate the housing 102 such as to direct UV photons on to the particles 104. As the UV photons impinge upon the particles 104, electrons are removed from the particles 104 and absorbed into the positively-charged housing 102. Consequently, the plurality of particles 104 becomes positively charged and the particles 104 repel one another. Additionally, the particles 104 repel the positively-charged housing 102.

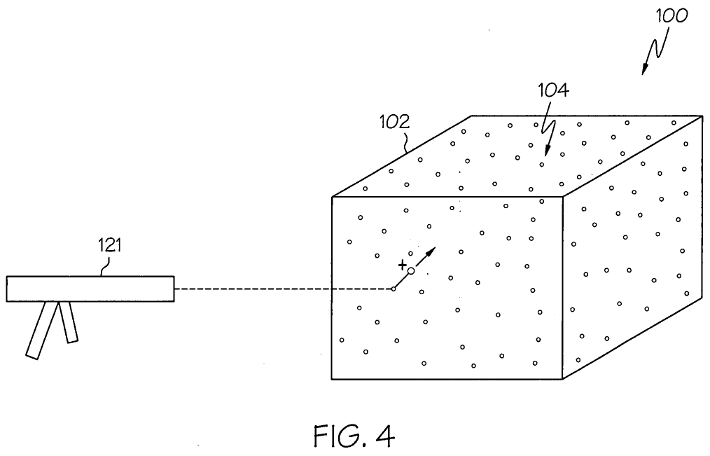

Another exemplary embodiment, depicted in FIG. 4, employs a high energy light source 121, a housing 102 constructed of a negatively-charged insulating material, and particles 104 that are initially neutrally or positively charged. During operation, the high-energy light source 121 is aimed at the particles 104. When the high-energy light impinges on one of the particles 104, a proton leaves the particle 104 and is absorbed in the negatively-charged insulating material. As a result, the particle 104 becomes negatively charged. As the light hits more particles 104, more of the particles 104 become negatively charged and, consequently, the like-charged particles 104 repel one another. Because the housing 102 is also like-charged, the particles 104 repel the housing 102 as well.

Turning back to FIG. 1, a magnetic field may be applied to the charged components of the system 100 to enhance the damping features of the system 100. In one exemplary embodiment, the system 100 includes a plurality of particles 104 comprising conductive material and a magnetic field coil 122. The magnetic field coil 122 includes a wire 124, power supply 126, and a shaft 128. The wire 124 is coupled to the power supply 126 and is coiled around the shaft 128. As those with skill in the art may appreciate, the power supply 126 coupled to the wire 124 may or may not be the same as the power supply 116 coupled to the housing 102. In either case, and as is generally known, when current from the power supply 126 flows through the wire 124, a magnetic field is produced.

When the system 100 vibrates, the application of the produced magnetic field to the system 100 causes the kinetic energy absorbed into the system 100 to dissipate as heat energy. This is due to the Lorentz effect, i.e. the combined effects of the applied magnetic field, the charged system 100, the induced magnetic field on the charged system 100 and the rate of flow of the particles 104. For example, the plurality of particles 104 in the system 100 may experience movement caused by mass vibration or the repulsion of the particles 104 from a like-charged particle or wall. The particles 104 may incidentally travel through the applied magnetic field, causing the particles 104 to produce an electrical current therein that creates an equal and opposite induced magnetic field relative to the applied magnetic field. However, because the particles 104 are made of conductive material, each may have an electrical resistance that prevents the electrical current from flowing freely through the particle 104. This resistance causes the kinetic energy of the particles 104 to convert to and dissipate as heat energy. As a result, particle 104 movement is dampened.

When the walls of the system 100 vibrate, the kinetic energy from the vibration is transferred to the plurality of particles 104 within the housing 102. As previously mentioned, the absorbed kinetic energy may cause the particles 104 to travel through the applied magnetic field and to dissipate the kinetic energy into heat. Consequently, the system 100 is damped. Moreover, when the mass to be damped experiences vibration, the vibratory motion of the mass is transferred to the system 100 and then to the particles 104.

The plurality of particles 104 within the system 100 also may be mixed through the use of two magnetic fields. As illustrated in FIG. 1, a second magnetic coil 142 may be positioned proximate the first magnetic coil 122 to produce a second applied magnetic field. As known by those with skill in the art, if a moving charge is placed within an applied magnetic field, a force F will be exerted on the charge. When two applied magnetic fields occupy the same space, each applied magnetic field exerts a force upon the charge. The resulting force acting upon the charge is determined by calculating the sum of the two forces. Thus, based on this premise the movement of a charge (e.g., the force exerted on the charge) may be manipulated by varying the components of the two applied magnetic fields or varying the magnetic flux of a given area of either or both of the two applied magnetic fields. These may be achieved by varying the amount of current passing through the magnetic coils 122, 124, or by any other known methods.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A mass damper for damping a mass, comprising:
an electrostatically charged housing configured to couple to the mass;
a plurality of electrostatically charged particles disposed within the housing, each particle electrostatically charged with like polarity to that of the electrostatically charged housing.

2. The mass damper of claim 1, further comprising a power source coupled to the housing and configured to supply an electric potential thereto.

3. The mass damper of claim 2, wherein the housing and plurality of particles each comprise a conductive material.

4. The mass damper of claim 1, wherein the housing comprises an insulating material and the plurality of particles comprise radioactive material.

5. The mass damper of claim 4, further comprising an ultraviolet (UV) light source configured to direct UV light on the plurality of particles.

6. The mass damper of claim 5, further comprising a power source coupled to the housing and configured to supply an electric potential thereto.

7. The mass damper of claim 6, wherein the housing comprises a conductive material and the plurality of particles comprises plastic.

8. The mass damper of claim 1, wherein the housing comprises a negatively-charged insulating material, the mass damper further comprising a high-energy light source configured to aim high-energy photons at at least one particle of the plurality of particles to thereby negatively charge the at least one particle.

9. The mass damper of claim 1, further comprising a magnetic field coil configured to provide a magnetic field through the housing.

10. The mass damper of claim 9, further comprising a second magnetic field coil configured to provide a second magnetic field through the housing.

11. The mass damper of claim 1, wherein the housing comprises a tube having first and second ends and endwalls coupled to the first and second ends of the tube, wherein the tube comprises ceramic and the endwalls comprise a metallic material.

12. The mass damper of claim 11, wherein a power source is coupled to the endwalls to induce a positive charge on the first endwall and a negative charge onto the second endwall.

13. A mass damper for damping a mass, comprising:
a housing configured to couple to the mass;
a plurality of particles disposed within the housing; and
a power source coupled to the housing, the power source configured to supply an electric potential thereto and electrostatically charge the housing, whereby when one of the particles of the plurality of particles contacts the housing, the particle is electrostatically charged.

14. The mass damper of claim 13, wherein the housing and plurality of particles each comprise a conductive material.

15. The mass damper of claim 13, wherein the housing comprises an insulating material and the plurality of particles comprise radioactive material.

16. The mass damper of claim 15, further comprising an ultraviolet (UV) light source configured to shine UV light on the plurality of particles.

17. The mass damper of claim 16, further comprising a magnetic field coil configured to provide a magnetic field through the housing.

18. A mass damper for damping a mass, comprising:
a housing comprising negatively-charged non-conductive material, the housing configured to couple to the mass;
a plurality of particles disposed within the housing; and
a high energy light source aimed at the plurality of particles configured to supply high-energy photons to at least one particle of the plurality of particles to thereby charge the particle.

19. The mass damper of claim 18, wherein the particle is negatively charged.
